(19) United States
(12) Patent Application Publication
(10) Pub. No.: US 2024/0157926 A1
(43) Pub. Date: May 16, 2024

(54) CONNECTING ARRANGEMENT FOR CONNECTION OF A HYDRAULIC FLUID LINE TO A HYDRAULIC APPARATUS OF A MOTOR VEHICLE

(71) Applicant: Continental Automotive Technologies GmbH, Hannover (DE)

(72) Inventor: Maximilian Kretschmer, Seligenstadt (DE)

(73) Assignee: Continental Automotive Technologies GmbH, Hannover (DE)

(21) Appl. No.: 18/505,233

(22) Filed: Nov. 9, 2023

(30) Foreign Application Priority Data
Nov. 16, 2022 (DE) 10 2022 212 222.4
Feb. 21, 2023 (DE) 10 2023 201 538.2

(51) Int. Cl. B60T 17/04

(52) U.S. Cl. CPC B60T 17/043

(57) ABSTRACT

A connecting arrangement for connection of a hydraulic fluid line to a hydraulic apparatus of a motor vehicle comprises a connecting pipe having a first pipe section at least partially inserted into a receiving bore in a connection body of the hydraulic apparatus. The connection body and the first pipe section are connected by a union screw. The connecting pipe also comprises a second pipe section to which a quick-connecting device is attached, a fluid line is also connected to the quick-connecting device.

### TECHNICAL FIELD

These embodiments relate to a connecting arrangement for connection of a hydraulic fluid line to a hydraulic apparatus of a motor vehicle.

### BACKGROUND

The prior art document discloses a pressure hose fastening with a pipe connection, which is intended for connecting a pressure hose to a hydraulic brake. The fastening arrangement comprises a hydraulic pipe with a union screw on a first side for fastening it to the brake housing. A hose nozzle which is intended for insertion into the pressure hose is provided on a second side of the hydraulic pipe. In addition, a hose sleeve is pushed on the second side of the hydraulic pipe, and therefore the pressure hose is pushed into the hose sleeve, the hose nozzle sliding into the pressure hose so that the pressure hose is firmly connected to the hydraulic pipe. However, the pressure hose is firmly connected to the hydraulic pipe and cannot easily be pulled off.

### SUMMARY

A connecting arrangement for connection of a hydraulic fluid line to a hydraulic apparatus of a motor vehicle is provided, which connecting arrangement can be connected and released in a simple manner.

A connecting arrangement for connection of a hydraulic fluid line to a hydraulic apparatus of a motor vehicle comprises a connecting pipe having a first pipe section at least partially inserted into a receiving bore in a connection body of the hydraulic apparatus. The connection body and the first pipe section are connected by a union screw. The connecting pipe also comprises a second pipe section to which a quick-connecting device is attached, a fluid line is also connected to the quick-connecting device.

### BRIEF DESCRIPTION OF THE DRAWINGS

FIG. 1 schematically illustrates a first embodiment of a connecting arrangement.

### DETAILED DESCRIPTION

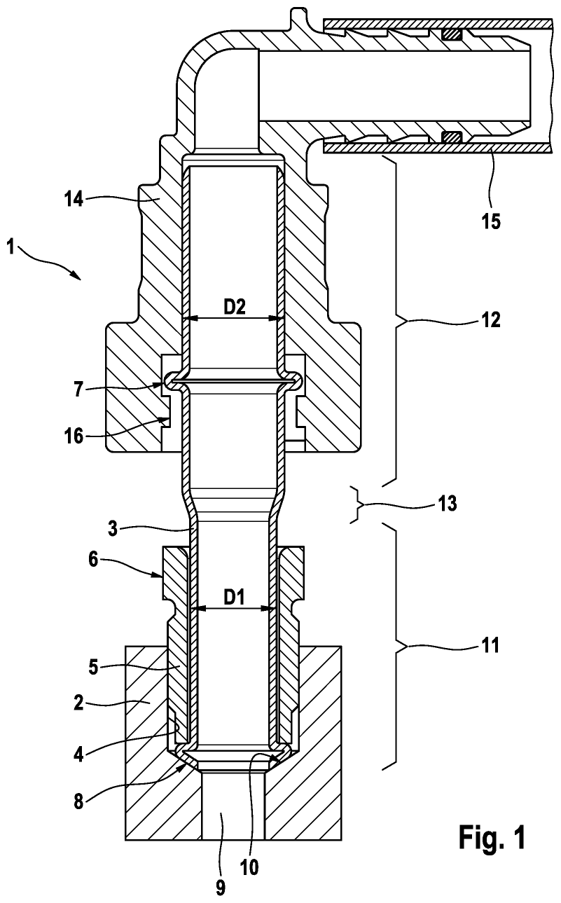

FIG. 1 shows, in section, a connecting arrangement 1 for connection of a hydraulic fluid line 15 to a hydraulic apparatus of a motor vehicle. The hydraulic apparatus may be a hydraulic unit, a wheel brake or a fluid reservoir of a motor vehicle brake system, with a corresponding connection body 2.

The connecting arrangement 1 comprises a metallic connecting pipe 3 which may be made of steel and is inserted into the connection body 2 of the hydraulic apparatus. For this purpose, the connection body 2 comprises a receiving bore 4 with an internal thread, not illustrated specifically. A union screw 5 is arranged rotatably around a first pipe section 11 of the connecting pipe 3. The union screw 5 comprises a through bore through which the first pipe section 11 of the connecting pipe 3 is inserted and an external thread, not illustrated specifically, by means of which the union screw 5 is screwed to the internal thread of the receiving bore 4. As a result, the connecting pipe 3 is firmly connected to the connection body 2. In addition, the union screw 5 comprises a hexagonal screw head 6, which is suitable for screwing the union screw 5 with a mounting wrench into the receiving bore 4.

For the pressure-tight sealing of the connecting pipe 3 in the receiving bore 4 and for captively securing the union screw 5, that end of the connecting pipe 3 which is inserted into the connection body 2 has been provided with a flange 8. This means that the first pipe section 11 having a first pipe diameter D1 is expanded at the inserted end of the connecting pipe 3.

In this case, the flange 8 of the connecting pipe 3 is designed in such a manner that the flanged pipe end is in pressure-tight contact with a conical sealing seat 10 of the receiving bore 4. By tightening of the union screw 5, the connecting pipe 3 with the flange 8 is pressed against the sealing seat 10 such that there is a hydraulically pressure-tight connection here. Furthermore, the receiving bore 4 via the sealing seat 10 enters a channel 9, which leads further into the hydraulic apparatus.

According to the example, the connecting pipe 3 comprises a second pipe section 12. The pipe section 12 has a second pipe diameter D2. The second pipe diameter D2 is larger than the first pipe diameter D1. In this case, the connecting pipe comprises an expanded transition section 13, at which the first pipe section 11 having a first pipe diameter D1 merges into a second pipe section 12 having a second pipe diameter D2. In a central region of the second pipe section 12, an encircling, radially outwardly projecting collar 7 is provided. The collar 7 can be produced by axial squeezing of the second pipe section 12. However, other methods or means of producing such a collar are also possible. For example, an encircling ring as a collar 7 can be welded or fitted by means of a press fit to the second pipe section 12.

With said collar 7, the second pipe section 12 of the connecting pipe 3 is used for receiving a quick-connecting device 14. The quick-connecting device 14 is inserted over the second pipe section 12 and fastened to the connecting pipe 3 by means of an integrated locking mechanism 16, which interacts with the collar 7. The locking mechanism 16 embraces the collar 7 such that the quick-connecting device 14 is secured against being pulled axially off the second pipe section 12. The locking mechanism 16 is mechanically actuable, and therefore the locking mechanism 16 is unlocked by actuation of same. In the process, the locking embracing the collar 7 expands such that the quick-connecting device 14 can be pulled off from the connecting pipe 3. This results in the production of a connection of a hydraulic fluid line to a hydraulic apparatus, which connection is fixed, but is also releasable.

1. A connecting arrangement for connection of a hydraulic fluid line to a hydraulic apparatus of a motor vehicle comprising:
a connecting pipe having a first pipe section, wherein the first pipe section is at least partially inserted into a receiving bore in a connection body of the hydraulic apparatus;
a union screw connecting the connection body and the first pipe section; and
a second pipe section to which a quick-connecting device is attached,
wherein a fluid line is connected to the quick-connecting device.

2. The connecting arrangement as claimed in claim 1, wherein the second pipe section of the connecting pipe comprises a collar which encircles the second pipe section on the outside and is provided for fastening the quick-connecting device to the connecting pipe.

3. The connecting arrangement as claimed in claim 2, wherein the quick-connecting device comprises a locking mechanism, which embraces the collar for fastening the quick-connecting device to the connecting pipe.

4. The connecting arrangement as claimed in claim 3, wherein the locking mechanism comprises a mechanical release for releasing the quick-connecting device from the connecting pipe.

5. The connecting arrangement as claim in claim 1, wherein the hydraulic apparatus is one of a hydraulic unit of a brake system, a wheel brake, and a fluid reservoir of a brake system.
